(19) United States
(12) Patent Application Publication
(10) Pub. No.: US 2008/0267725 A1
(43) Pub. Date: Oct. 30, 2008

(54) High Speed Industrial Hole Saw for Production Line Applications

(76) Inventor: Stanley Luke Mills, Lawrenceville, GA (US)

Correspondence Address: STANLEY L. MILLS, P.O. BOX 491525, LAWRENCEVILLE, GA, 30049-0026, US

(21) Appl. No.: 11/741,774

(22) Filed: Apr. 30, 2007

(51) Int. Cl. B23D 77/00

(52) U.S. Cl. 408/203.5

(57) ABSTRACT

Although useful in many industrial applications for wood, plastic or non-ferrous metals, this original form of this concept is tailored to the wood I-joist industry. One of the benefits of using wooden I-joist construction versus conventional sawn lumber joists is the ability of cutting holes for duct work and other mechanicals to pass through the system. For this to occur in an industrial environment extreme requirements must be met. The cutting rate for a production machine of this type must be unusually fast for hole saw operations. The size of hole cut is necessarily quite large. Combined with an extreme cutting rate this produces unusually large torque and fatigue requirements. Because manual extraction of the cut material would be cumbersome and consume excessive time, a means of automatic ejection of the “divot” is required. With the varying depth and width of beams to be processed comes the need for simple, quick and accurate adjustment to the machine and multiple or variable cutting diameters.

### REFERENCES CITED

“Carbide Tipped Hole Saws”, “Master Grit Recessed Lighting Hole Saw”, and “One Toothed Wood Hole Cutter” by American Saw and Manufacturing Company downloaded from www.lenoxsaw.com.

### FIELD OF THE INVENTION

This invention relates to hole saw cutting tools in general. The specific design is for rapidly cutting wood, composite wood, or wood-like materials such as rigid foams, plastics and soft metals. Although the specific machine described in this application is for the wooden I-joist industry, the cutting tool and general concept of the machine could have applications in a multitude of wood and wood-like material processing operations.

### BACKGROUND OF THE INVENTION

Typical hole saw cutting operations are small (6″ diameter or less) and slow (hand held units cutting at rates of ½″ per minute or less and drill press rates somewhat faster). The typical wood cutting hole saw with the piloted arbor has extremely limited uses in high-speed production environments. Moreover the lack of automatic divot ejection makes the already slow process worse. What is needed in an industrial production environment is a hole saw with the cutting rate, simplicity of use and durability of an industrial “chop saw”. The hole saw design described in this application has a feed rate of approximately 2″ per second in the diameters already produced. The design of the teeth and the angle of set cause a slight self-feeding action, which increases the speed of the cutting operation.

Typical hole saw operations require a pilot drill to stabilize the saw and control wobble. Wobble and stability are achieved in this design by the mass and rigidity of the machine and hole saw and the inherent stability of the monoset tooth design. A pilot drill is not required.

Because of the desirability of duct holes in wooden I-joist construction many methods have been developed to cut these holes. Routers with templates and hand held circular and rotary saws are the most common. These methods are labor intensive, relatively slow in a production environment and inaccurate. Over-cut holes and notched flanges are common. The hole saw and machine described in this application overcome these problems by accurately and quickly cutting duct-size holes with little physical effort giving the user a marked advantage in production capability over other methods of duct hole cutting.

Wooden I-joists are manufactured in a variety of widths and depths. This dictates that a machine designed to cut duct holes be readily adjustable, or adaptable for these changes.

### DETAILED DESCRIPTION OF THE CLAIMS FROM THE DRAWINGS

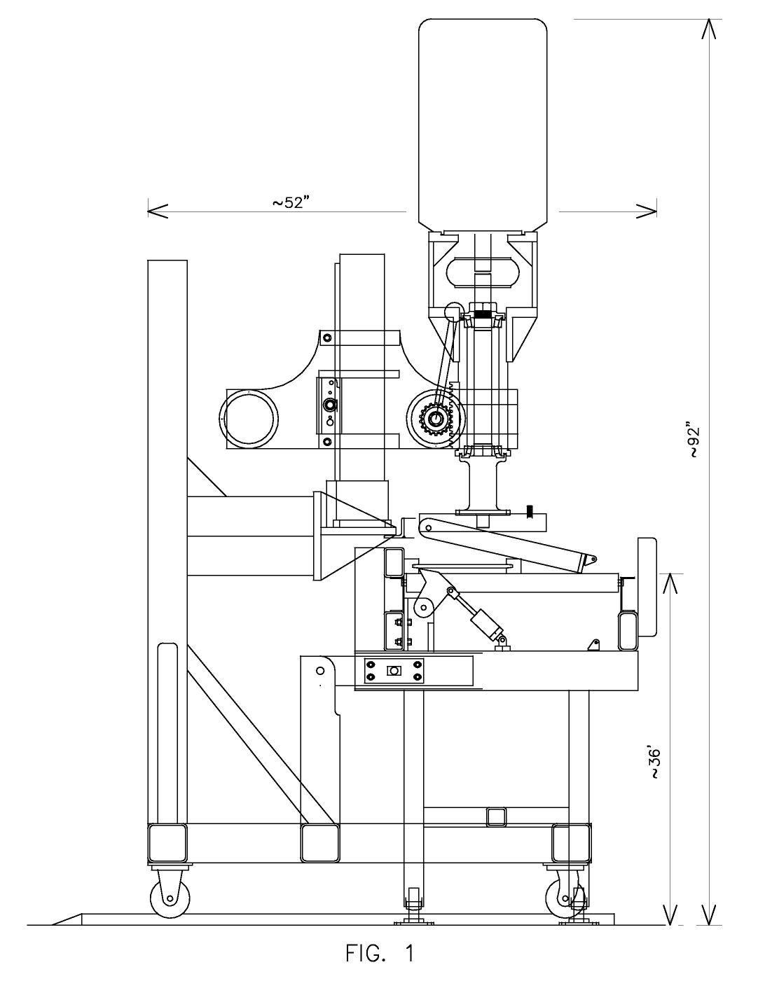

FIG. 1. shows the left side view of the entire machine without details with overall dimensions.

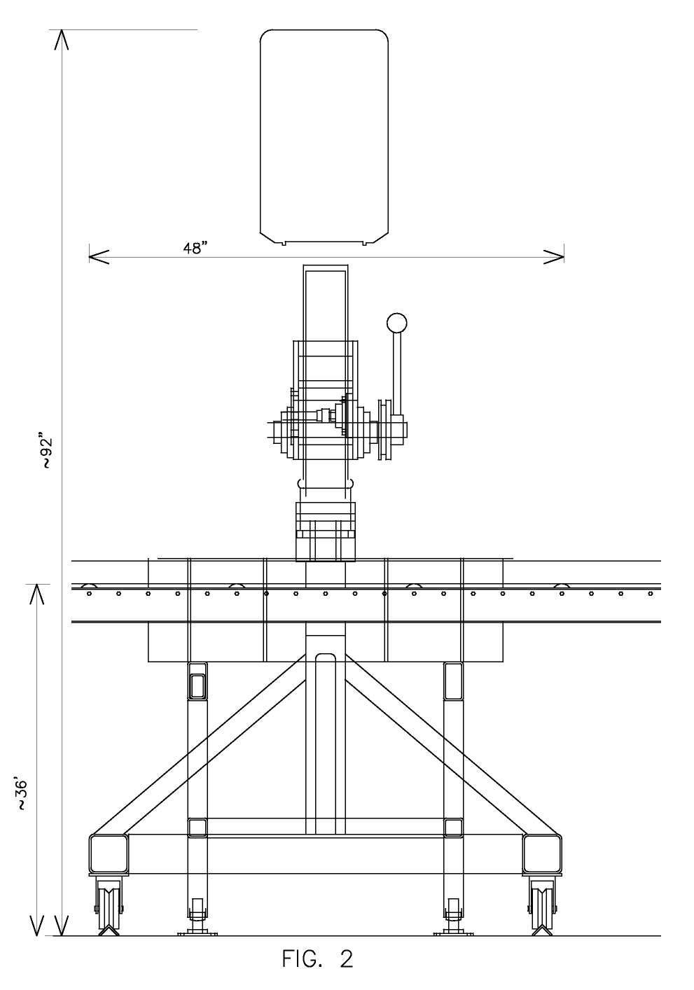

FIG. 2. shows the front view of the almost complete machine without details with overall dimensions.

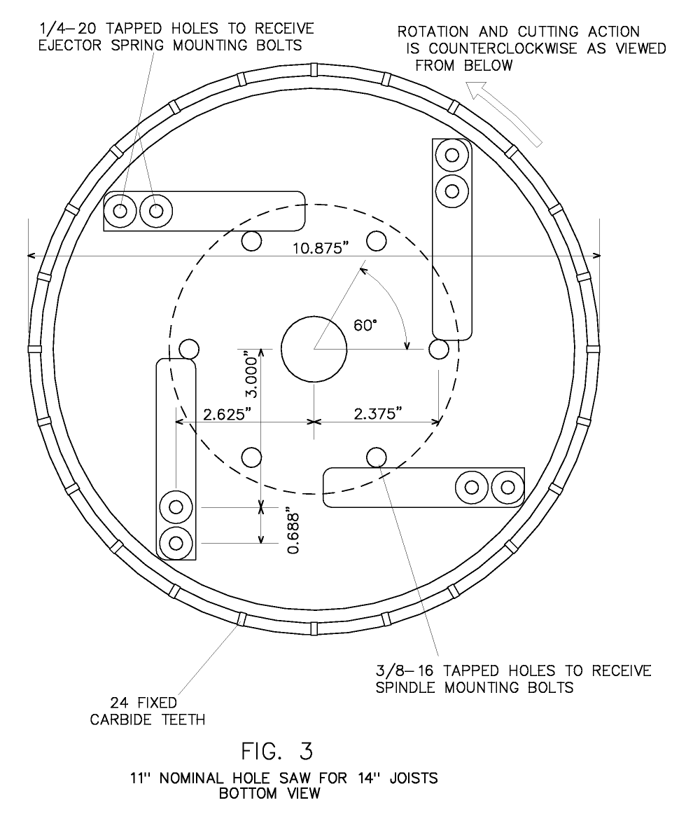

FIG. 3. shows the bottom view of the general layout of the hole saw cutter in the 11″ nominal size for 14″ joists. The bottom view shows the layout of the teeth, mounting bolts and the flat spring ejectors. The gross layout is similar to hole saws in general. The mass and proportions have been rearranged to facilitate rapid, short stroke cutting.

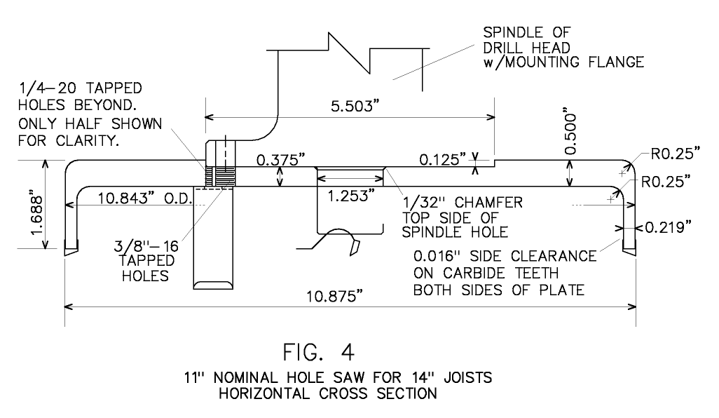

FIG. 4. shows the side cut away view of the 11″ cutter. It shows the drive hub of the spindle inlet into the upper surface of the saw plate.

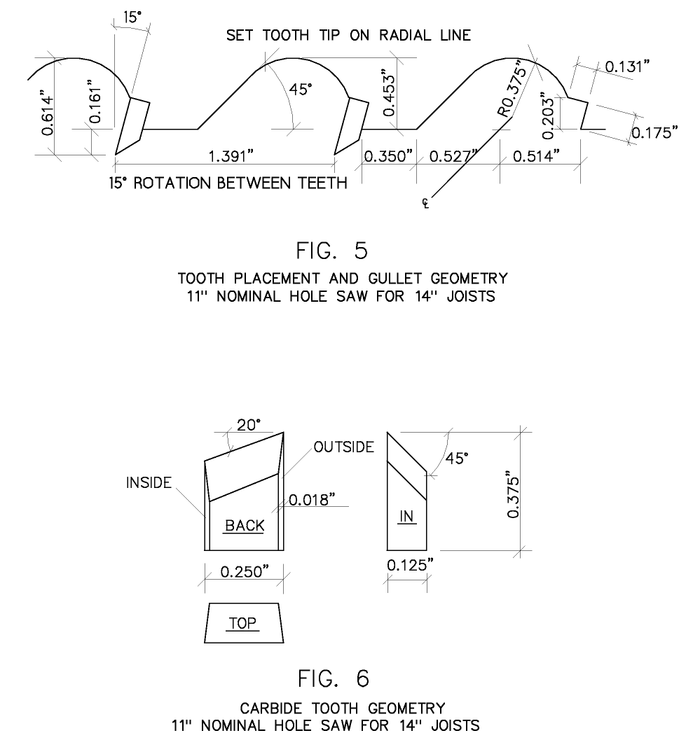

FIG. 5. shows the tooth position and gullet design for the 11″ cutter. The angle of cut is more aggressive than usual in a hole saw. Typical hole saws are made to be used by hand in a power drill or at best used in a drill press held in a key tightened chuck. Neither of those scenarios is possible with this cutter. The extreme forces generated by the aggressive cutting action preclude these applications. The gullet size and shape is designed to allow enough chip storage to avoid chip compaction during the cutting operation on the thickest of wooden I-joist webs—approximately ½″. This is necessary for rapid production line cutting to avoid having to back the blade out to clear chips.

FIG. 6. shows the shape of the carbide cutting teeth. The tooth shape is similar to the shape of carbide teeth for an alternating bevel cross cut saw used in cabinetmaking—the teeth do not alternate though. All teeth are beveled with the tip on the outside of the saw rim. This is done to provide a better-finished edge on the joist side of the cut and to produce a self-stabilizing effect.

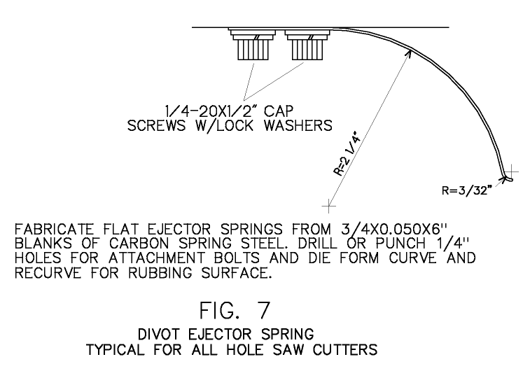

FIG. 7. shows the design of the flat springs used to eject the divot—typical for all cutters. In cutting complete circles, all springs are constantly engaged during the entire cutting process—a relatively gentle application. In cutting partial circles, the springs are alternately engaged and disengaged as the cutter turns causing extreme abuse to these parts. The relatively low mass of the flat springs allows them to take this beating well. The simple design holds the cost of replacements down.

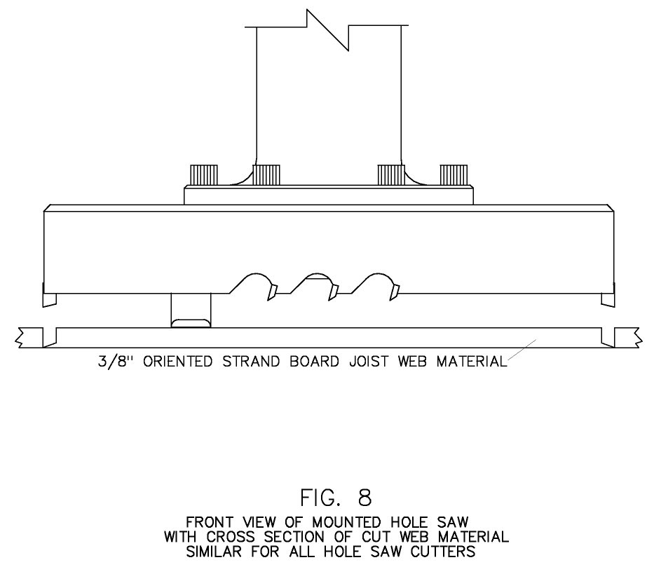

FIG. 8. shows a sketch of the 11″ cutter bolted to the spindle flange and the cross section of the cut in joist web material. Only some of the teeth and one of the ejector springs are shown for clarity.

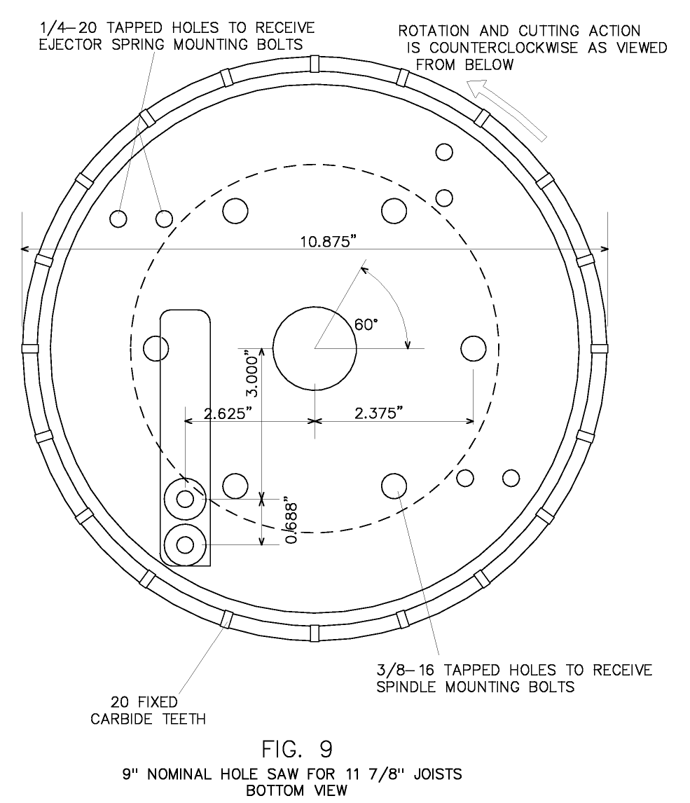

FIG. 9. shows the bottom view of the general layout of the hole saw cutter in the 9″ nominal size for 11⅞″ joists. The bottom view shows the layout of the teeth, mounting bolts and the flat spring ejectors. The orientation of the mounting boltholes remains constant in all diameter cutters. The orientation of the ejector springs varies to fit the different diameters.

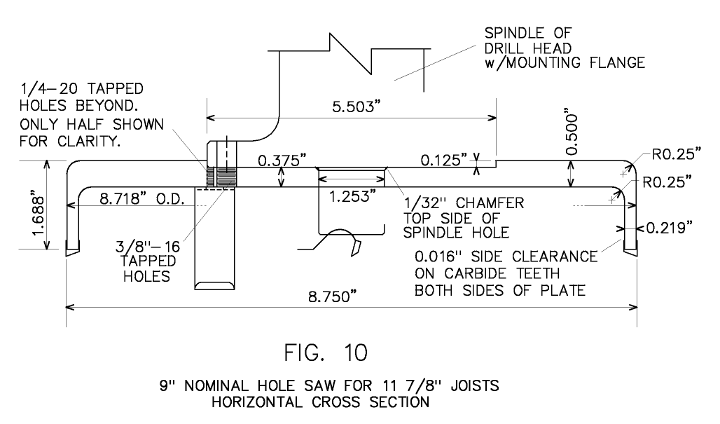

FIG. 10. shows the side cut away view of the 9″ cutter. It shows the drive hub of the spindle inlet into the upper surface of the saw plate.

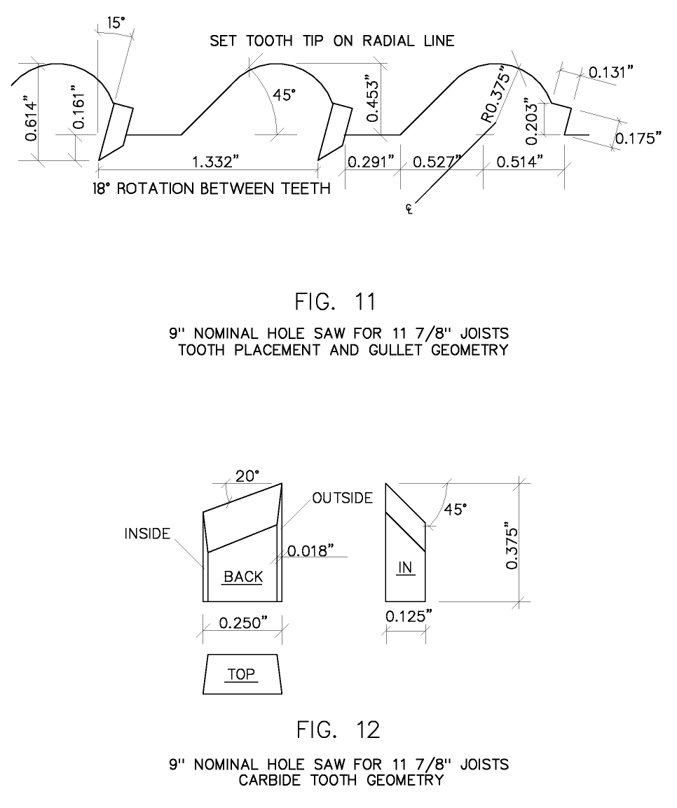

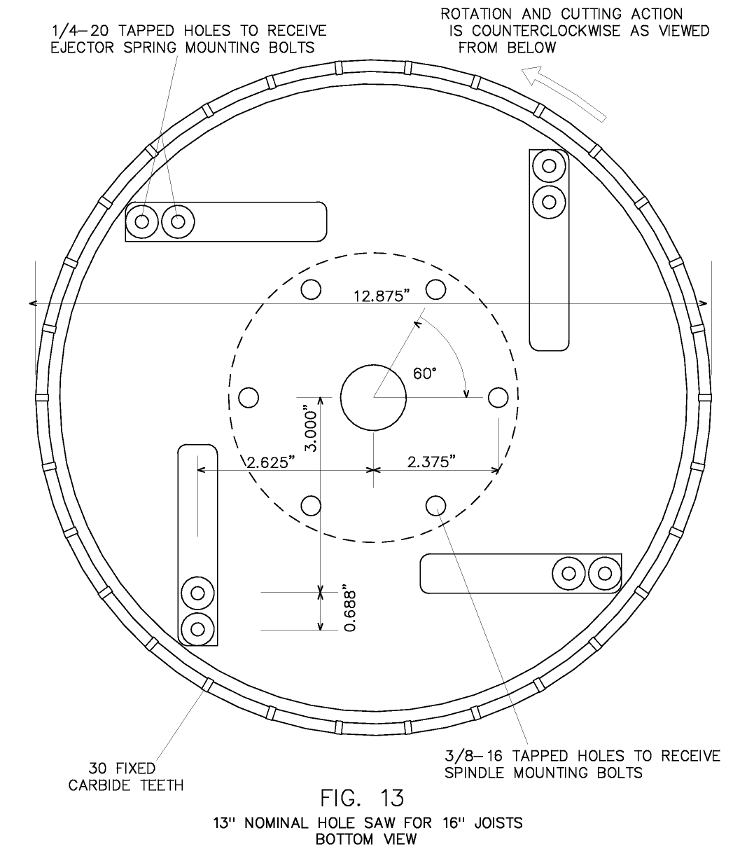

FIGS. 11 and 12. show the tooth position, gullet design and tooth geometry for the 9″ cutter. The gullet design and tooth geometry is constant for all cutters. The number of teeth and tooth placement varies with diameter.

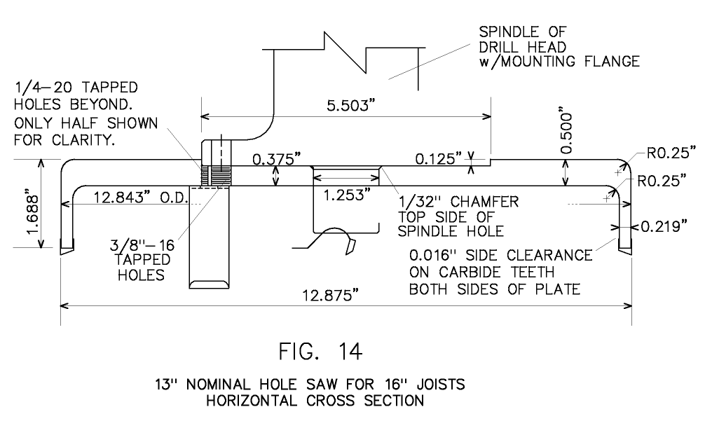

FIG. 13. shows the bottom view of the general layout of the hole saw cutter in the 13″ nominal size for 16″ joists. The bottom view shows the layout of the teeth, mounting bolts and the flat spring ejectors. The orientation of the mounting boltholes remains constant in all diameter cutters. The orientation of the ejector springs varies to fit the different diameters.

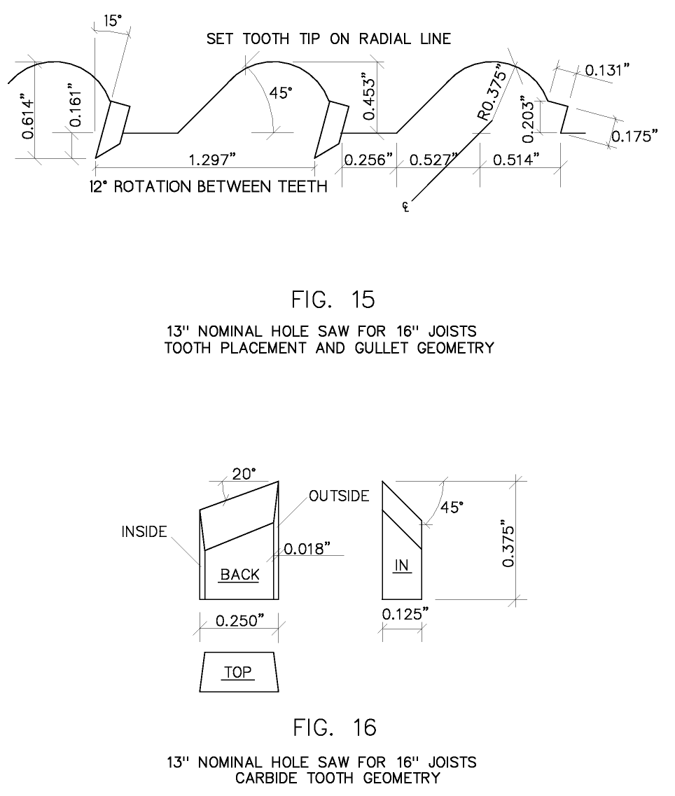

FIG. 14. shows the side cut away view of the 13″ cutter. It shows the drive hub of the spindle inlet into the upper surface of the saw plate.

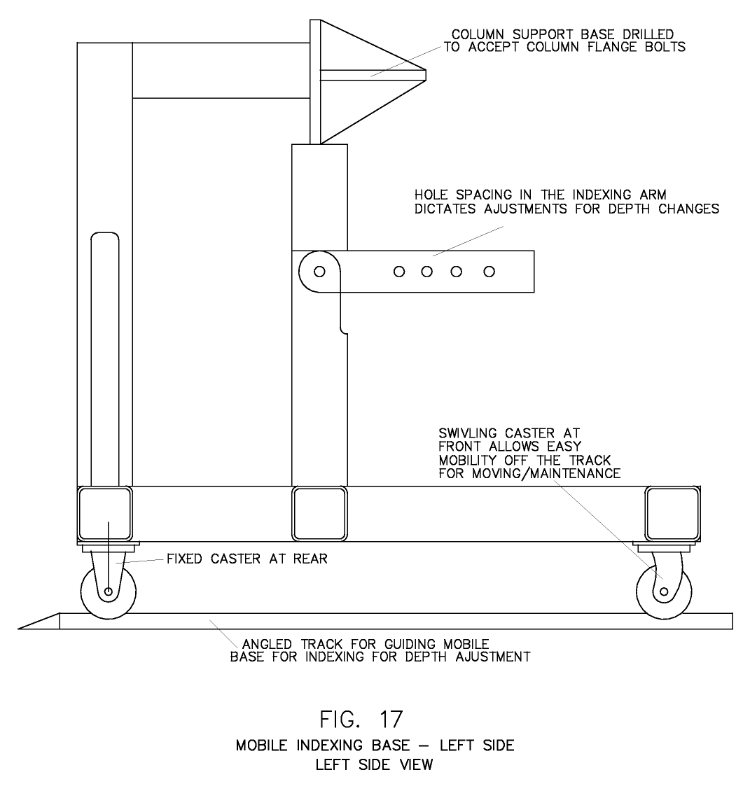

FIGS. 15 and 16. show the tooth position, gullet design and tooth geometry for the 13″ cutter. The gullet design and tooth geometry is constant for all cutters. The number of teeth and tooth placement varies with diameter.

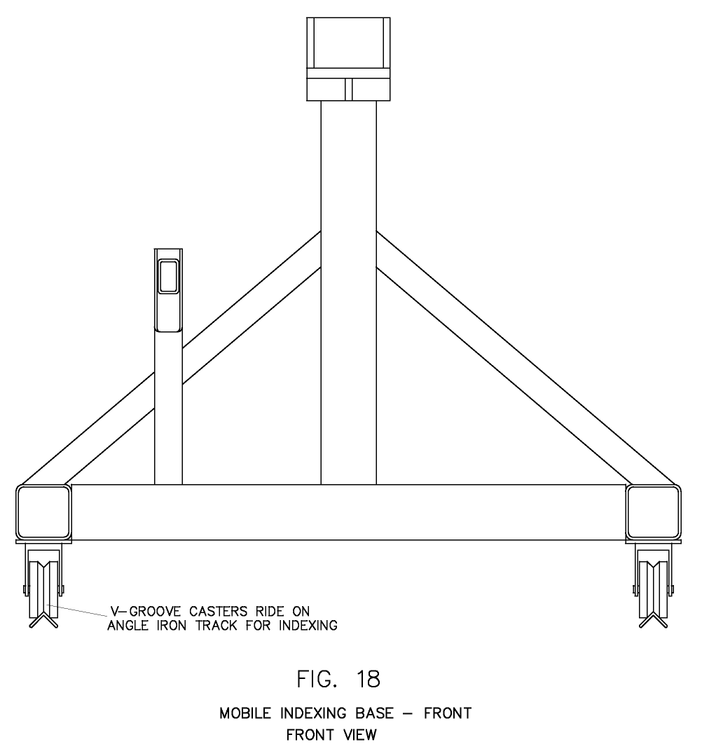

FIG. 17. shows the left side view of the mobile indexing base. The base is constructed of steel plate and tubing. V-grooved, iron casters allow for precise machine alignment in indexing and for mobility of the machine for maintenance and replacement. An index pin fitted through holes in the indexing bar aligns with a fixed pinhole in the fixed base to adjust for varying depths of joists.

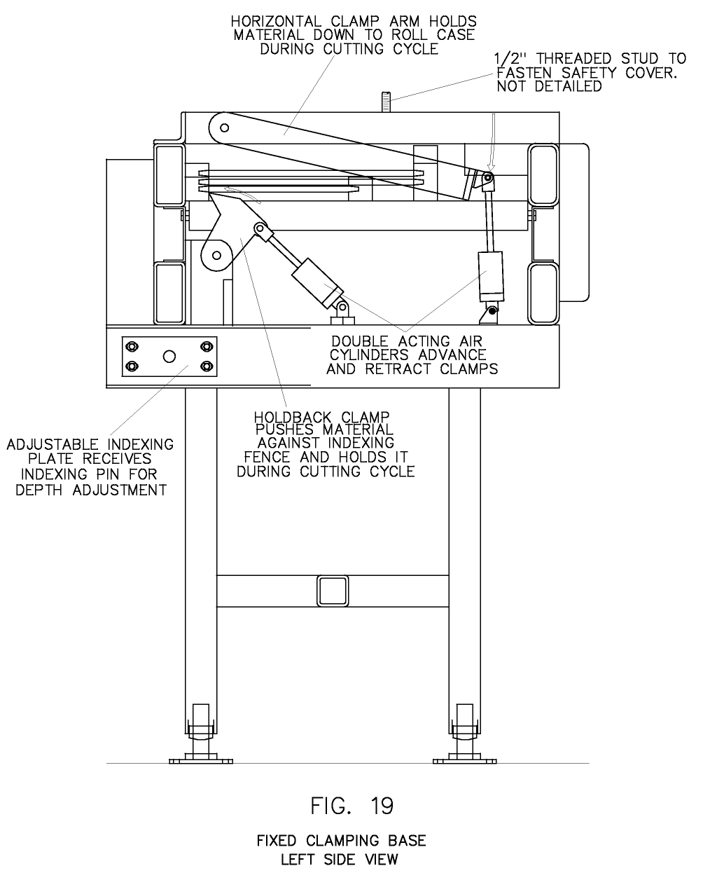

FIG. 18. shows the front view of the mobile indexing base. It shows the V-grooved casters riding on the angle iron tracks allowing forward/backward movement only for depth indexing.

FIG. 19. shows a left side view of the fixed base that supports the roll case for transferring the I-joists on the production line. It also houses the clamping mechanisms for holding the material rigidly in place during the cutting operation. FIG. 19. shows the base with adjustable legs to allow for matching existing roll case heights. A fixed version is also possible for initial installations where roll case height can be specified.

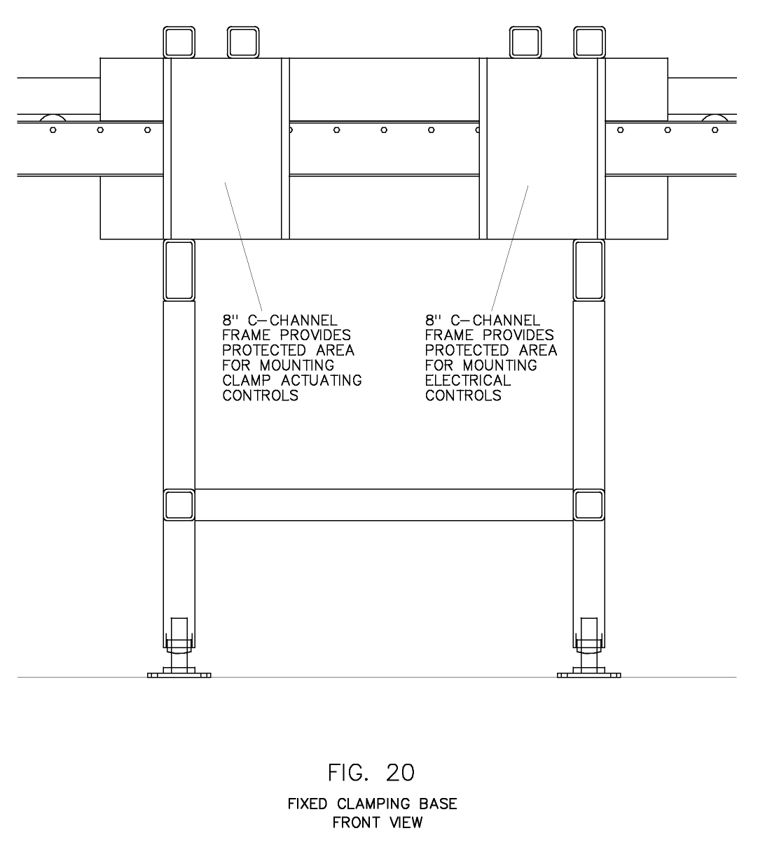

FIG. 20. shows the front view of the fixed base. The 8″ C-channels used as the vertical members in the frame are support surfaces for control mounting.

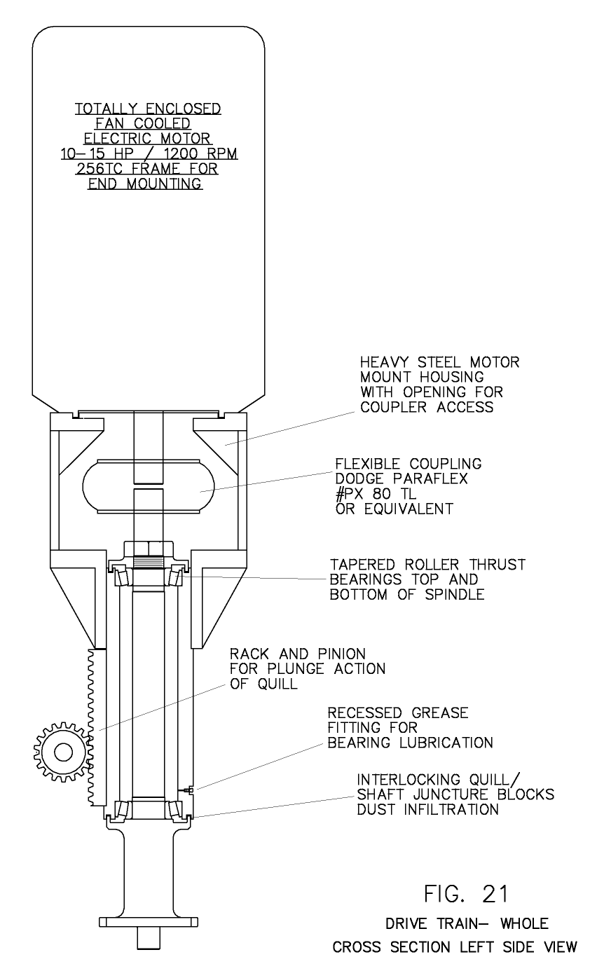

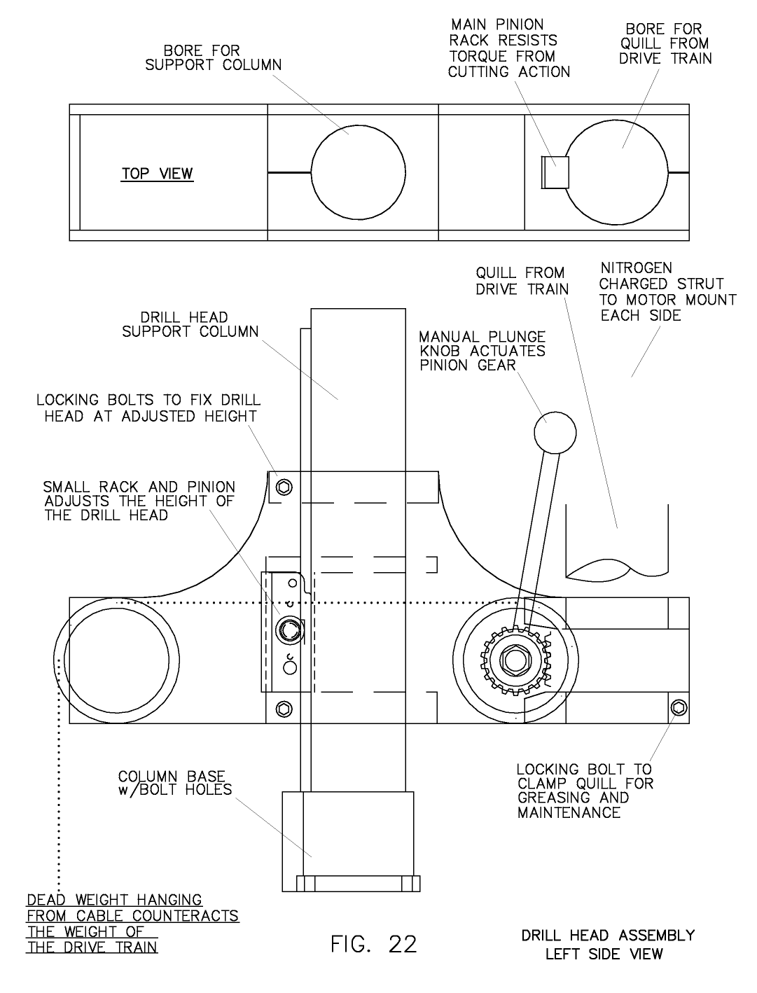

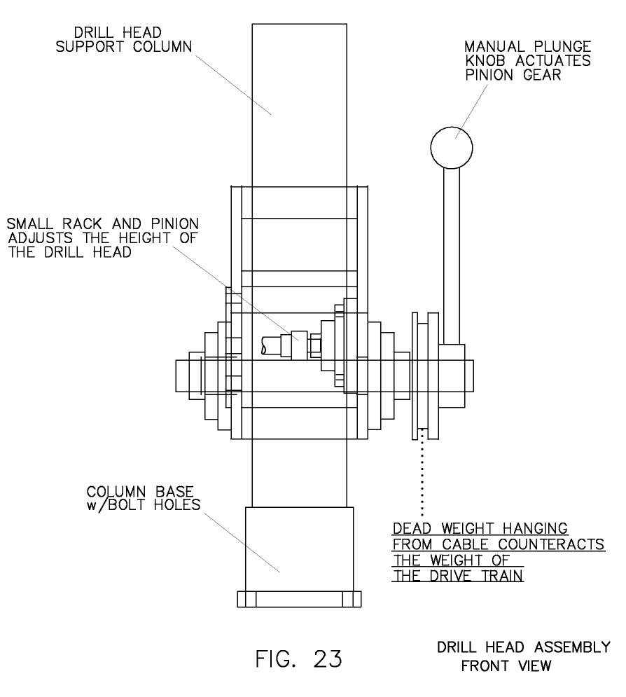

FIG. 21. depicts the drive train of the machine. It is direct driven through a flexible coupling. A heavy spindle with a bolting flange to mount the cutting heads is held by tapered roller bearings in a plunging quill. The bearings are pre-loaded with a fine threaded nut. The quill is manually plunged by a lever handle similar to a standard drill press. The clamping mechanism is actuated by the left hand and the plunge is affected by the right precluding having one's hand under the cutter when it plunges. The substantial weight of this direct drive system is offset by dead weight and pulley system seen in FIGS. 22 and 23.

FIG. 22. shows the left side and top views of the drill head. It supports the drive train and contains the rack and pinion gears for adjusting the height of the head and the plunge mechanism. The balancing weight puts a torque directly into the plunge pinion gear via a cable and pulley system. This system puts a very slight return pressure on the quill. Additional return pressure is supplied by a charged strut on either side to provide a positive return and to counter balance the torque created by the pinion gear pressure.

FIG. 23. shows the front view of the drill head. It more clearly shows the cable sheave and pillow blocks supporting the riser and plunge shafts.

What is claimed is:

1. A tool for rapidly cutting a large diameter, circular or partial circular opening in wood, plastic or non-ferrous metals and automatically expelling the circular or partially circular divot comprising:
a) a hollow cylindrical body
b) threaded back plate for attachment to a drive shaft with single or multiple connectors
c) the perimeter milled for chip clearance gullets
d) multiple carbide cutting teeth brazed to or mechanically locked to the body rim
e) ejectors powered by compressed air or flat or coiled springs

2. A machine designed with the power and rugged nature to employ the tool of claim 1 in the wooden I-joist industry to cut duct holes in wooden I-joists comprising:
a) a fixed base for handling, indexing and clamping wooden I-joists of varying depths and widths with stops and clamps designed to automatically adapt to varying flange widths
b) a mobile base for mounting the drive mechanism and tool that allows easy indexing for depth adjustment and easy mobility for maintenance or replacement
c) an indexing system to adjust the cutting position for various depth and width I-joists
d) a drive spindle and quill for rapid plunge cutting capable of enduring the extreme torque and fatigue of the cutting operation
e) an interlocking pattern for quill and spindle mating to protect open tapered thrust bearings from fine wood dust contamination
f) a balancing mechanism incorporating both direct torque by gravity on the manual plunge mechanism's main shaft and gas operated struts for vertical load balancing of the heavy motor/drive/cutter assembly
